(19) United States
(12) Patent Application Publication
(10) Pub. No.: US 2008/0001377 A1
(43) Pub. Date: Jan. 3, 2008

(54) Axle Assembly

(76) Inventor: Vladimir Rogic, Stuttgart (DE)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 10/594,265

(22) PCT Filed: Mar. 24, 2005
(86) PCT No.: PCT/DE05/00547

§ 371 Date: Jun. 26, 2007

(30) Foreign Application Priority Data
Mar. 31, 2004 (DE) 102004015636.0

(51) Int. Cl. B60G 3/14

(52) U.S. Cl. 280/124.125

(57) ABSTRACT

The invention relates to an axle assembly of a non-trackbound curve-tilting vehicle. Said axle assembly comprises a lower dual-arm cross-bar (2) that can be pivoted about a lower medium longitudinal axis (1) of a frame or body (100) of the vehicle and that has an arm that is associated with the right vehicle side and an arm that is associated with the left vehicle side. An upper dual-arm cross-bar (3) can be pivoted about an upper medium longitudinal axis (3) of the frame or body (100) of the vehicle and has an arm that is associated with the right vehicle side an arm that is associated with the left vehicle side. A right-hand support part (5) is hinged on the right vehicle side to the free ends of the right arms of the cross-bars (2,4). A left-hand support part (6) is hinged on the left vehicle side to the free ends of the left arms of the cross-bars (2,4). The assembly also comprises a spring-mounted wheel suspension (7) of a right-hand wheel on the right-hand support part (5) and a spring-mounted wheel suspension (8) of a left-hand wheel on the left-hand support part (6).

The invention relates to an axle assembly according to the claims.

Protection is claimed not only for the combinations of characteristics indicated or represented explicitly in the claims and/or in the following description and/or in the drawings. Rather, protection is also claimed in principle for any secondary combinations of the above-mentioned characteristics.

In the drawing, an example of an axle assembly according to the invention is represented. In the drawing

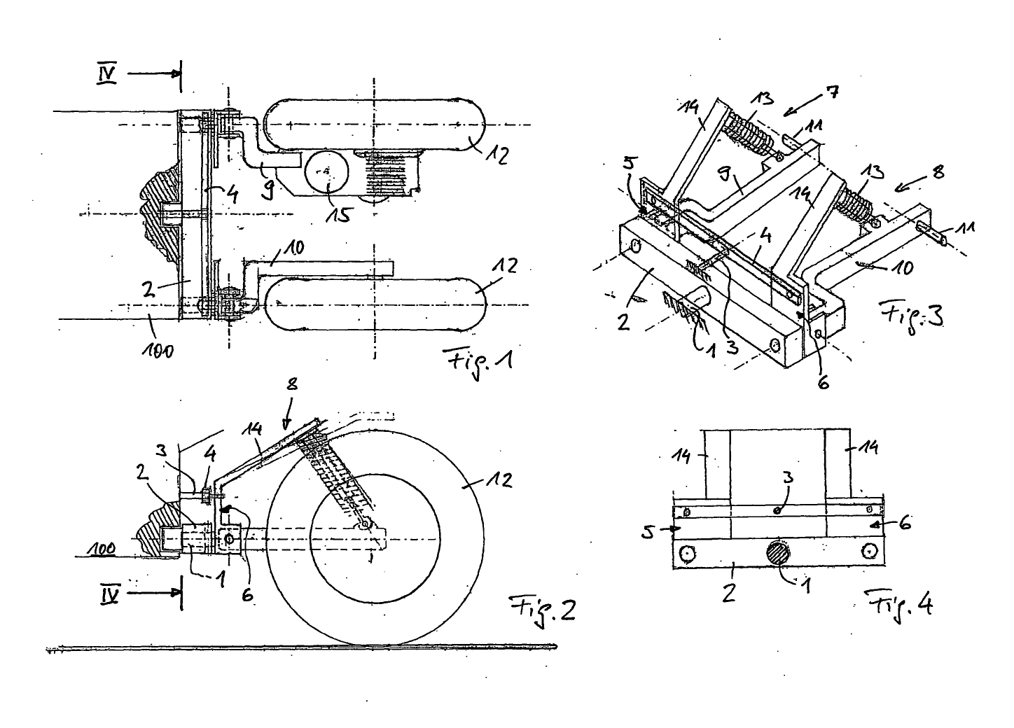

FIG. 1 shows a top view,

FIG. 2 shows a side view,

FIG. 3 shows a perspective representation, and

FIG. 4 shows a front view along the cross section line IV-IV in FIGS. 1 and 2.

On a vehicle frame or vehicle body 100, which is indicated only in FIGS. 1 and 2, a lower dual-arm cross-bar 2 is arranged, which can pivot about a lower medium longitudinal axis 1 of the frame or structure 100. In addition, an upper cross-bar 4 is provided, which can pivot about an upper medium longitudinal axis 3 of the frame or body 100.

A right-hand support part 5 as well as a left-hand support part 6 are hinged to the free ends of the two arms of the cross-bars 2 and 4, where each hinge axis is parallel to the medium longitudinal axes 1 and 3. The result is that the support parts 5 and 6 with the cross-parts 2 and 4 form a parallelogram-like composite, where the vertical axes of the support parts 5 and 6 in each case are oriented at least approximately parallel to the vertical axis of the body 100, because the medium longitudinal axes 1 and 3 are fixed rigidly to the body 100 and extend in a plane of the body which contains the medium longitudinal axis and the medium vertical axis.

Each support part 5 and 6 supports a right-side and a left-side spring-mounted wheel suspension 7 and 8, respectively, which can be constructed according to an advantageous embodiment of the invention as a longitudinal rocker 9 and 10, respectively, each of which is attached in a manner which allows pivoting about a diagonal axis on the associated support part 5 and 6, respectively.

Each rocker 9 and 10, respectively, supports an axle 11 for receiving a wheel 12.

Each rocker 9 and 10, respectively, abuts by means of a spring unit 13 with spring action against a counter bearing arm 14.

At least one of the rockers, in the example of FIG. 1, the right rocker 9, can be constructed as a motor driven rocker, which supports a motor 15 for driving the wheel 12 which is guided by the respective rocker. The motor 15 can be coupled to the associated wheel 12 via a continuously variable transmission system, or, in principle, in any desired manner.

If both rockers 9 and 10 are constructed as motor driven rockers, then, as a result of an appropriate motor control, the torque transfer to the wheels 12 is at least approximately identical.

The vehicle 100 can present a similarly constructed, additional, axle assembly with steerable wheels, if a four-wheel vehicle is to be constructed.

However, it is also possible and advantageous to construct the vehicle as a three-wheel vehicle, where the represented axle assembly supports the rear wheels of the vehicle and a single, steerable, wheel is provided as front wheel in an arrangement corresponding to a motorcycle or a scooter.

The wheels 12 of the represented axle assembly can be arranged with small wheel track, so that the result is a scooter or a motorcycle with two adjacently arranged rear wheels which are sloped to the side in the same manner as the vehicle body.

Such a three-wheel motorcycle or this three-wheel scooter can be driven like a conventional motorcycle or a conventional scooter.

Optionally, in the case of driving at a slow speed (creeping speed) and an upright vehicle body 100, the possibility can be provided to inhibit the potential pivoting motion of at least one of the cross-bars 2 and 4, respectively, by means of a manually actuated, or automatically operated, control, so that the driver of the vehicle can stop for parking in the upright position, without having to put down his/her feet to brace the vehicle, or using a stand.

The above-mentioned stopping advantageously acts on the lower cross-bar 2 which is constructed, in the represented example, as a load bearing cross-bar, while the upper cross-bar 4 has substantially only a steering function and is intended to guide the cross-bars 5 and 6, and thus the radial planes of the wheels 12, always parallel to the vertical medium longitudinal plane of the body, which plane contains the longitudinal and vertical axes of the body 100. Instead of the non-load-bearing upper cross-bar 4, it is also possible to provide transverse links which are separate from each other, for the purpose of maintaining the support parts 5 and 6 in the diagonal direction of the vehicle.

1. Axle assembly of a non-trackbound curve-tilting vehicle, with
a lower dual-arm cross-bar (2), which can be pivoted about a lower medium longitudinal axis (1) of a frame or a body (100) of the vehicle, with an arm which is associated with the right vehicle side and an arm which is associated with the left vehicle side,
an upper dual-arm cross-bar (4), which can be pivoted about an upper medium longitudinal axis (3) of the frame or body (100) of the vehicle, with an arm which is associated with the right vehicle side and an arm which is associated with the left vehicle side,
a right-side support part (5) which is hinged on the right vehicle side to the free ends of the right arms of the cross-bars (2, 4),
a left-side support part (6) which is hinged on the left vehicle side to the free ends of the left arms of the cross-bars (2, 4),
a spring-mounted wheel suspension (7) of a right-hand wheel on the right-hand support part (5), and
a spring-mounted wheel suspension (8) of a left-hand wheel on the left-hand support part (6).

2. Axle assembly according to claim 1,
characterized in that,
as wheel suspensions (7, 8), in each case a spring-mounted rocker (9, 10), which can be pivoted, is provided about a diagonal axis of the right and left support part (5, 6), respectively, on the corresponding support part.
